(19) United States
(12) Patent Application Publication
(10) Pub. No.: US 2026/0077774 A1
(43) Pub. Date: Mar. 19, 2026

(54) Method for Evaluating Sensor Signals

(71) Applicant: Robert Bosch GmbH, Stuttgart (DE)

(72) Inventors: Steffen Baab, Gensingen (DE); Jorge Juan Robles, Leonberg (DE); Oleg Wolf, Stuttgart (DE)

(21) Appl. No.: 19/328,166

(22) Filed: Sep. 14, 2025

(30) Foreign Application Priority Data
Sep. 16, 2024 (DE) 10 2024 208 799.8

(51) Int. Cl. B60W 50/02; B60W 50/00

(52) U.S. Cl. CPC B60W 50/0205; B60W 2050/0049; B60W 2050/0056; B60W 2050/021; B60W 2050/0215; B60W 2520/105

(57) ABSTRACT

A method for evaluating sensor signals in a vehicle is disclosed. A sensitivity error is determined as part of the evaluation, and the method includes the following: (i) in the event of a low-dynamic state of the vehicle, performing an offset correction on the sensor signals, (ii) evaluating the dynamic state of the vehicle based on the sensor signals and comparing the dynamic state with threshold values in order to evaluate the activation of a monitoring function, and (iii) calculating relative deviations and comparing these relative deviations with limit values in order to evaluate the sensor signals.

This application claims priority under 35 U.S.C. § 119 to application no. DE 10 2024 208 799.8, filed on Sep. 16, 2024 in Germany, the disclosure of which is incorporated herein by reference in its entirety.

The disclosure relates to a method for evaluating sensor signals and an arrangement for carrying out the method.

### BACKGROUND

Sensors are devices that are used to capture physical quantities and convert them into electrical signals. These signals can then be further processed to control certain functions or processes. In motor vehicles, various sensors, which are also used in combination, are used to record different variables. An inertial measurement unit (IMU) is a spatial combination of one or more inertial sensors, such as acceleration sensors and rotation rate sensors.

Sensors are devices that are used to capture physical quantities and convert them into electrical signals. These signals can then be further processed to control certain functions,

In motor vehicles, many applications, such as autonomous driving (AD) functions, require the use of reliable sensor signals. For this reason, redundant IMU sensor architectures are used, which typically employ the same physical event to capture sensor errors. To do this, the signal deviations from the redundant signals are monitored. One example of such an application is the use of three angular rate sensors arranged on the same circuit board.

The valid redundant signals are combined, which is also referred to as fusion, or a selection algorithm can be implemented to select the “best” signal in terms of functional safety integrity and signal accuracy from all possible signals.

The redundant sensor sets can have different properties. For example, some sensors may have greater sensitivity errors or scaling errors than other sensors. It is obvious that using the signals that have a smaller error can increase the accuracy of the final signal.

### SUMMARY

Against this background, a method and an assembly according to description below are presented. Embodiments arise from the description below as well.

The method presented is based on the following considerations:

Safety thresholds are usually defined not only for offset errors, but also for sensitivity deviations, i.e. scaling errors. In these cases, it may also be necessary to monitor these error patterns in order to react accordingly if the sensitivity error is greater than the defined safety threshold. One reaction could, for example, be to set the signal to invalid if a diagnostic threshold value is exceeded.

Individual monitoring of sensitivity errors as an independent variable is difficult to implement. In the further explanations, monitors are also explained, namely monitor 1 for an absolute offset deviation and monitor 2 for a relative deviation in a dynamic signal, excluding offset.

Reference is made to FIG. 1. The relative errors are defined as:
ideal signal S_{id}(t) or physical signalS_{phys}(t), the following applies:

$${S}_{id} ( t ) = {S}_{phys} ( t ) ,$$

i.e. there is no static offset, no detection error, no CAS (Cross Axis Sensitivity) and no noise.

A real signal with errors (sᵢ or s_{ref}) is given by:

$${S}_{i} ( t ) = {SF}_{i} {SF}_{id , i} ( t ) + {S}_{i}^{off} + {MA}_{ji} {S}_{id , j} ( t ) + {MA}_{ki} {S}_{id , k} ( t ) + Noise + …$$

S_{id,i}(t), S_{id,j}(t) and S_{id,k}(t) are the ideal signals in the three axes.

$${S}_{i}^{off}$$

is the offset in axis i, and SFᵢ is the scaling factor in axis i and MA denotes a misalignment factor in relation to the other axes j and k.

By neglecting the CAS and noise contribution, the following results:

$${S}_{i} ( t ) = {SF}_{i} {S}_{id , i} ( t ) + {S}_{i}^{off}$$

$${S}_{i}^{off} = {S}_{i ( t )} {\vert}_{{S}_{phys} \to 0} \qquad {S}_{i}^{off} \neq f ( t )$$

This means that in an offset-free signal, the sensitivity error is calculated by:

$$SENS\_ERROR = SF - 1$$

A scaling factor of 1 is ideal, i.e. there is no deviation of the sensor signal from the ideal signal.

In the case of remaining offsets, the following dependency applies:
Monitor 2 approach: Compare relative difference of the average signals

It is assumed that it is possible to generate a reference signal S_{ref} e. g., the mean value of all redundant signals, which is applied as an ideal signal without offset or scaling errors

$$( {S}_{ref}^{off} \to 0 , {SF}_{ref} \to 1 ) .$$

Therefore,

$$\overline{{S}_{m}} ( t )$$

is the average of the signal Sᵢ(t) during a certain time period, S_{ref} is an average reference signal, which is taken here as the average S_{id}(t), due to the mentioned assumption, and

$${S}_{m}^{off}$$

is the offset with respect to the reference signal.

Relative deviation from average signals:

$$\vert \frac{( \overline{{S}_{m}} ( t ) - \overline{{S}_{ref}} ( t ) )}{\overline{{S}_{ref}} ( t )} \vert = \vert \frac{( {S}_{m}^{off} \pm SF \overline{{S}_{ref}} ( t ) - \overline{{S}_{ref}} ( t ) )}{\overline{{S}_{ref}} ( t )} \vert = \vert ( SF - 1 ) \pm \frac{{S}_{m}^{off}}{\overline{{S}_{ref}} ( t )} \vert$$

The relative deviation of the sensor signal to a reference, e.g. to an average value of several of these signals, depends on the sensitivity error (SF-1) of the sensor signal channel and the offset error of the sensor signal.

Monitoring the sensitivity error, i.e. a relative deviation of the sensor signal output to a reference, is worsened by the residual offset of the signal. This error contribution decreases as the size of the reference signal increases.

An example is shown below:
Offset error in signal 2 mg, no sensitivity error, no misalignment
Situation with low dynamics, e.g. driving on the highway without taxes
Actual acceleration in Y-direction: 20 mg

$$( ( Sig - Ref ) / Ref - 1 ) * 100 = ( - 18 / 201 ) * 100 = - 10 \% -> virtual sensitivity error due to offset$$

Situation with high dynamics, e.g. cornering
Actual acceleration in Y-direction: 200 mg

$$( ( Sig - Ref ) / Ref - 1 ) * 100 = ( - 198 / 200 - 1 ) * 100 = - 1 \% -> virtual sensitivity error due to offset$$

Two measures are therefore required to increase the quality of sensitivity monitoring:
1) Reduce the offset of the signal before sensitivity monitoring,
2) Evaluate the sensitivity error only with a sufficiently high dynamic range in the signals.

A method for evaluating sensor signals in a vehicle is presented. These sensor signals are configured as sensor signals from an inertial measuring unit. A sensitivity error is determined as part of the evaluation. The method comprises the following steps:
in the event of a low-dynamic state of the vehicle, perform an offset correction on the sensor signals. A low dynamic is given, for example, when the vehicle is stationary.

The dynamics here must be so low that a potential scaling error does not affect the static offset value.

This is followed by evaluating the dynamic state of the vehicle based on the sensor signals and comparing the dynamic state with threshold values in order to evaluate the activation of a monitoring function. If the dynamic range is low, the monitoring of the sensitivity error is low. If this is high, monitoring is active.

Relative deviations are then calculated and these relative deviations are compared with limit values in order to evaluate the sensor signals.

Threshold values (Thd) are values that can be used to define certain behaviors. If, for example, the signal is greater than Thd_Start, then sensitivity monitoring is active. A further threshold value is given, for example, if it is defined whether a vehicle is in a low dynamic state or not (signal <Thd_lowdynamic→the vehicle is in stationary mode).

Limit values are also threshold values. These are used here in such a way that if the detected sensitivity error is smaller than the limit value, the signal is set as invalid.

It is then typically intended to label or mark the sensor signals accordingly.

An algorithm for monitoring the sensitivity is thus presented, which contributes to an offset correction before monitoring. This algorithm also enables a state based on vehicle dynamics.

The targeted approach comprises two activities:
1. Correct

$${S}_{m}^{off}$$

during driving conditions with low dynamics,
2. Define minimal

$$\overline{{S}_{ref , min}} ( t ) .$$

$$\overline{{S}_{ref , min}} ( t )$$

is the minimum reference signal required to enable sensitivity monitoring. If the reference signal is smaller than this threshold value, relative monitoring will not be active, as it is assumed that this relative error of the signal is very small in order to be detected correctly.

Further advantages and embodiments of the disclosure are shown in the description and the accompanying drawings.

It is understood that the abovementioned features and those to be explained below can be used not only in the combination indicated in each case, but also in other combinations or on their own, without departing from the scope of the present disclosure.

### BRIEF DESCRIPTION OF THE DRAWINGS

FIG. 1 shows graphs of signal curves to illustrate a signal error model for AD signals.

FIG. 2 shows a graph of signal curves to illustrate a relative difference between offset-corrected signals. The graph illustrates the monitoring concept for AD signals.

FIG. 3 shows the structure of the sensitivity detection in a block diagram.

FIG. 4 shows a flowchart of a possible sequence of the presented method.

FIG. 5 shows a highly simplified, purely schematic illustration of a vehicle with an arrangement for carrying out the method.

### DETAILED DESCRIPTION

The disclosure is illustrated schematically by way of embodiments in the drawings and is described in detail below with reference to the drawings.

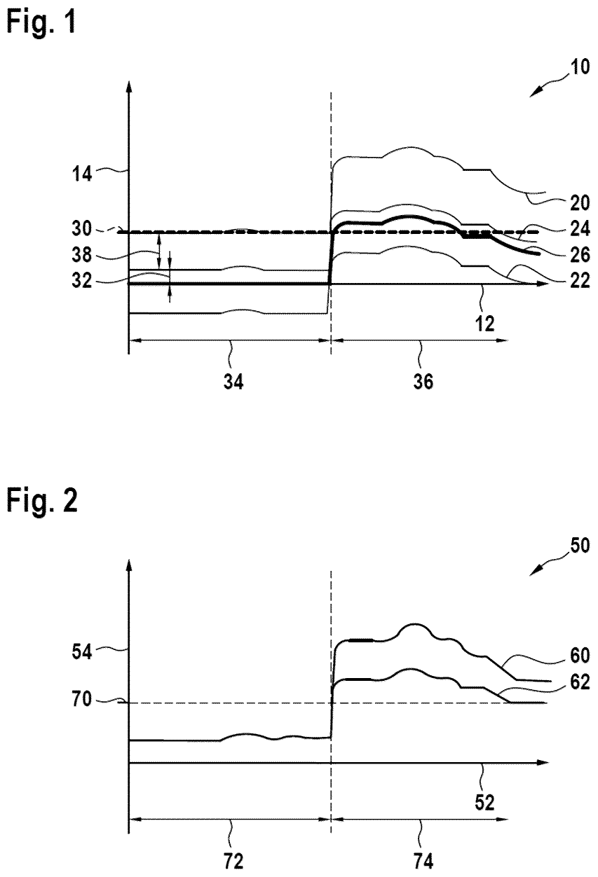

FIG. 1 shows in a graph 10, on whose abscissa 12 the time and on whose ordinate 14 a signal level is plotted, curves of sensor signals S₁ 20 and S₂ 22 as well as S_{id} 24 and S_{ref} 26. The ordinate 14 shows a threshold value (TH:threshold) 30, i.e. if S_{ref}<TH30, then a situation with low dynamics, and a temporary assumption

$${S}_{ref}^{off} 32.$$

This is the absolute offset of the reference signal, which is ideally 0 at standstill. A first double arrow 34 indicates a static range, a second double arrow 36 indicates a dynamic range. A third double arrow 38 illustrates the static offset

$${S}_{i}^{off} .$$

FIG. 2 shows a graph 50, on the abscissa 52 of which the time is plotted and on the ordinate 54 of which a signal level is plotted, to illustrate the signal monitoring definitions according to monitor 2, curves of sensor signal S₁ 60 and reference signal S_{ref} 62. FIG. 2 shows in particular the difference in the signal after the offset has been corrected. This can be seen because in the first static part, both curves “reference signal” and influenced signal are the same. This is because the existing offset has been removed.

A threshold value TH 70 is shown at ordinate 54, i.e. if S_{ref}<TH70, then the situation has low dynamics. A first double arrow 72 indicates a static range, a second double arrow 74 indicates a dynamic range.

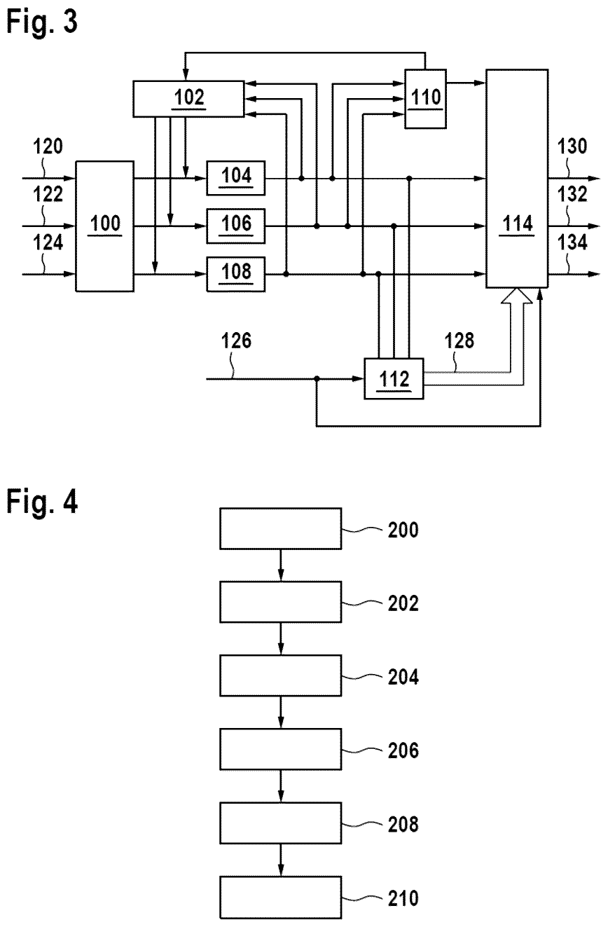

FIG. 3 shows a diagram of the sensitivity detection according to monitor 2. The illustration shows a low-pass filter (15 Hz) 100, an online offset correction 102, three units 104, 106, 108 for averaging, a reference signal calculation (median) 110, a state calculation 112 and a unit 114 for threshold comparison and evaluation. Inputs are sensor signals S₁ 120, S₂ 122 and S₃ 124. Further signals relate to additional information 126 and a signal for activation/deactivation 128. Outputs are signals Validity S₁ 130, Validity S₂ 132 and Validity S₃ 134.

FIG. 4 shows a flowchart illustrating a possible sequence of steps in the presented method This method implements an algorithm that comprises the following steps.

In a first step 200, all input signals are pre-filtered with a low-pass filter. Subsequently, in a second step 202, an average of all signals is calculated over a certain number of data sets. In a third step 204, a reference signal (median) is then calculated based on the filtered redundant signals.

In the event of a sufficiently low dynamic range, e.g. in the event of a standstill, an offset correction algorithm is applied to the input signals before filtering in a step 206. The low dynamics can be determined by analyzing all accelerations and angular rates at a specific point in time. For example, at a standstill it is expected that the angular rates and the acceleration in the same plane are close to zero, the vertical acceleration at 1g. If the condition is met, offsets are calculated and saved for each signal with reference to a reference. Offset correction takes place continuously during normal operation. Parameters are updated in an update cycle if preconditions are met.

In a step 208, based on the average signals, the dynamic state of the vehicle is evaluated, which is referred to as a state calculation, and compared to specific threshold values that define an activation of the monitoring itself. A decision is made:
a) The vehicle dynamics are low, resulting in inactive sensitivity error monitoring.
b) The vehicle dynamics are high, resulting in active sensitivity error monitoring.

In a step 210, relative deviations are calculated in the monitoring as described above and compared with certain limit values derived from safety targets of the signals. If the limit value is exceeded, the signals are marked as invalid for receiving units. This results in safety monitoring for sensitivity errors.

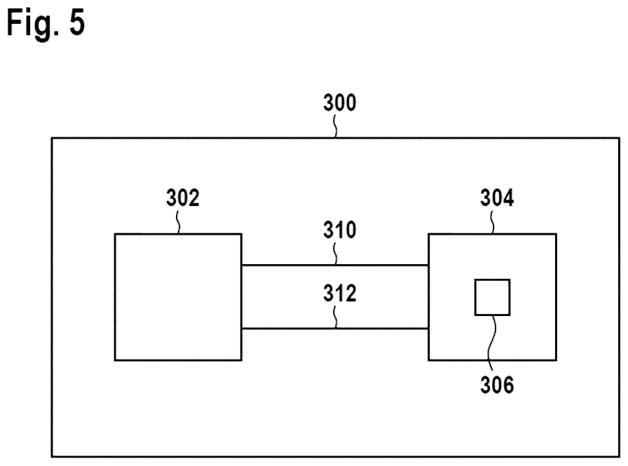

FIG. 5 shows a purely schematic illustration of a vehicle, which is labeled with the reference number 300. In this vehicle, an inertial measurement unit (IMU) 302 and an embodiment of an arrangement for carrying out the method presented are provided, which in turn is designated by the reference numeral 304. The arrangement 302 has an evaluation unit for carrying out the method. The arrangement 304 and/or the evaluation unit 306 is/are integrated in a hardware and/or software. Furthermore, the arrangement 304 can be integrated into a control unit of the vehicle 300 or designed as such a control unit.

The IMU 302 provides sensor signals 310, 312 which are analyzed according to the method presented herein in order to evaluate these sensor signals 310, 312.

What is claimed is:

1. A method for evaluating sensor signals in a vehicle, wherein a sensitivity error is determined as part of an evaluation, the method comprising:
in the event of a low-dynamic state of the vehicle, performing an offset correction on the sensor signals;
evaluating the dynamic state of the vehicle based on the sensor signals and comparing the dynamic state with threshold values in order to evaluate an activation of a monitoring function, and
calculating relative deviations and comparing the relative deviations with limit values in order to evaluate the sensor signals.

2. The method according to claim 1, wherein the low dynamic state is determined by analyzing all accelerations and angular rates at a specific point in time.

3. The method according to claim 1, wherein the sensor signals are filtered in advance by a low-pass filter.

4. The method according to claim 1, wherein an average value formation is performed on the sensor signals.

5. The method according to claim 1, wherein a reference signal is calculated from the sensor signals.

6. The method according to claim 1, wherein, when the evaluation of the sensor signals shows that the sensor signals deviate too much from the limit values, the sensor signals are marked accordingly.

7. The method according to claim 1, wherein the method is performed on an inertial measurement unit.

8. An arrangement for evaluating sensor signals with an evaluation unit which is configured to carry out the method according to claim 1.

9. The arrangement according to claim 8, which is configured for evaluating sensor signals of an inertial measurement unit.
